(19) United States
(12) Patent Application Publication
(10) Pub. No.: US 2007/0218267 A1
(43) Pub. Date: Sep. 20, 2007

(54) Reflective composition and garment

(76) Inventor: Thomas F. Votel, Sunfish Lake, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/384,007

(22) Filed: Mar. 17, 2006

(51) Int. Cl. B32B 15/08; B32B 7/08

(52) U.S. Cl. 428/223; 428/102; 428/313.3; 442/286; 442/228; 442/236; 442/237; 442/316; 442/376; 442/380; 442/394; 156/93

(57) ABSTRACT

A reflective composition and a garment or other article to which reflective composition is affixed. The reflective composition comprising a reflective layer, an optional first protective film overlaying the reflective layer, and an exterior second protective film.

### BACKGROUND OF THE INVENTION

1. Field of the Invention

This invention relates to reflective compositions present on garments and the like and, in particular, this invention relates to reflective compositions resistant to wear.

2. Background

Garments and other devices having reflective materials are widely used. These reflective materials often function as safety devices to ensure that a person or object is readily noticed. One such use is garments to which a reflective material is affixed. Garments of this nature are often used in road construction or repair, traffic control, or in other situations in which it is desirable that a person is readily recognizable so that motorists will avoid injuring the person. Another use is affixing reflective materials to exterior surfaces of signs, vehicles, fuel tanks, and the like with the purpose that these objects will be readily recognizable and often avoided by motorists and equipment operators, thereby avoiding damage occurring when vehicles and other equipment impact these objects.

Garments, or other devices, to which fees reflective materials are affixed are often worn in situations in which the garments are subjected to abrasion, thereby eroding or deteriorating these reflective materials and, consequently, reducing the reflective properties thereof.

There is then a need for a reflective material or composition with enhanced resistance to wear.

### SUMMARY OF THE INVENTION

This invention substantially meets the aforementioned needs of the industry by providing a reflective material or composition with enhanced resistance to abrasion and wear and a garment, or other object, to which the reflective material or composition is operably affixed.

There is provided a reflective garment for covering at least a portion of a user, the garment comprising a fabric and a reflective composition attached to an outer surface of the fabric. The reflective composition may include a reflective layer, optionally a first protective film, and an exterior second transparent film. The first protective film may be an integral part of the reflective layer, optionally embedded thereto during a manufacturing process. Alternatively, the first protective film may be absent, or essentially so. If the first protective film is absent from the instant reflective composition, the second protective film is attached to overlay the reflective composition. If the first protective film is present in the instant reflective composition, the second protective film is attached so as to overlay the first protective found. In neither case, the second protective film may be attached by connectors such as stitching.

A reflective composition for attaching to a garment is also provided. The reflective composition may include a reflective layer, a first transparent protective film, and an exterior second transparent protective film. The reflective layer may include a plurality of microspheres. The first protective film may be disposed above the reflective layer. The second protective film may be disposed above the first protective film.

A method of making a reflective garment is yet further provided. The method may include attaching a reflective composition to the garment, in which the reflective composition includes a reflective layer, an optional first transparent film disposed above the reflective layer, and a second transparent film disposed over the first film.

It is a feature of this invention to provide an additional transparent film over a reflective composition. It is an advantage of the foregoing feature that the enhanced transparent film will have additional resistance to wear and abrasion. It is another advantage of the foregoing feature that garments with the enhanced reflective composition will wear longer. It is yet another advantage of the foregoing feature that garments with the enhanced reflective composition will function for a longer period of time without the necessity of replacement. It is still yet another advantage of the foregoing feature that garments with the enhanced reflective composition of this invention will have a longer useful life, thereby reducing expenses of industries in which these garments are utilized.

These and other objects, features, and advantages of this invention will become apparent from the description which follows, when considered in view of the accompanying drawings.

### BRIEF DESCRIPTION OF THE DRAWINGS

This invention relates to, and can be further described with reference to, the accompanying drawings, wherein like reference numerals refer to like parts in the several views.

FIG. 1 is a cross section of a first embodiment of the reflective composition of this invention;

FIG. 2 is a cross section of a second embodiment of the reflective composition of this invention;

FIG. 3 is a cross section of a third embodiment of the reflective composition of this invention;

FIG. 4 is a front view of a shirt on which the reflective composition of this invention is present;

FIG. 5 is a front view of a coat on which the reflective composition of this invention is present;

FIG. 6 is a perspective view of a cap on which the reflective composition of this invention is present;

FIG. 7 is a front view of a vest; on which the reflective composition of this invention is present;

FIG. 8 is a front view of a pair of shorts on which the reflective composition of this invention is present; and

FIG. 9 is a front view of a pair of pants on which the reflective composition of this invention is present.

It is understood that the above-described figures are only illustrative of the present invention and are not contemplated to limit the scope thereof.

### DETAILED DESCRIPTION OF THE INVENTION/DRAWINGS

Unless otherwise defined, all technical and scientific terms used herein have the same meaning as commonly understood by one of ordinary skill in the art to which this invention belongs. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting. All dimensions of the components in the attached figures may vary with a potential design and the intended use of an embodiment of the invention without departing from the scope of the invention.

Each of the additional features and methods disclosed herein may be utilized separately or in conjunction with other features and methods to provide improved embodiments of this invention and methods for making the same. This detailed description is merely intended to teach a person of skill in the art further details for practicing preferred aspects of the present teachings and is not intended to limit the scope of the invention. Therefore, combinations of features and methods disclosed in the following detailed description may not be necessary to practice the invention in the broadest sense, and are instead taught merely to particularly describe representative embodiments of the invention.

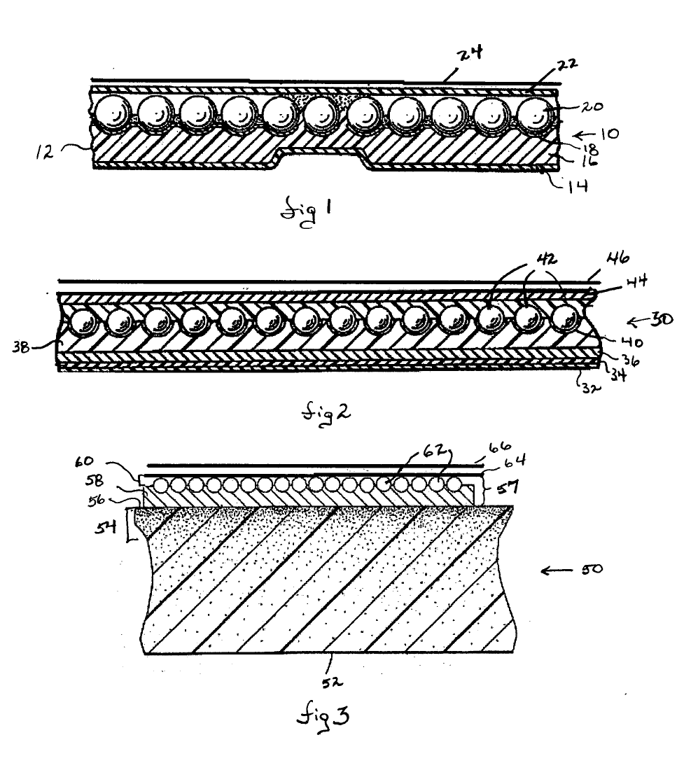

Referring to FIG. 1, a suitable embodiment of a reflective composition is depicted generally at 10. In this embodiment, a reflective material 12 has a release layer 14, a binder layer 16, a reflective layer 18, a layer of microspheres 20, an optional first protective (cover) film 22, and a second protective (cover) film 24. This and similar embodiments are disclosed in U.S. Pat. No. 3,190,178.

FIG. 2 shows a second embodiment of a suitable reflective composition at 30, which includes respective non-softenable and softenable layers 32 and 34, an optional support sheet 36, a binder layer 38, a reflective layer 40, a microsphere layer 42, an optional first protective (cover) film 44, and a second protective (cover) film 46. Suitable materials and protocols for making the second embodiment of the reflective composition can be found in U.S. Pat. No. 5,378,520.

FIG. 3 depicts another reflective composition at 50 and has a fabric 52 having a fluorescent layer 54 with an increasing concentration of pigments, the pigment concentration at a maximum proximate an outer surface 56 of the fabric 52. Also included in the composition 50 is a partial layer 57 having a resin layer 58, a reflective material layer 60 and a layer of microspheres 62. In a generally overlaying position, an optional first protective (cover) film 64 may be disposed. A second protective (cover) film 66 is present to overlay an exterior surface of the reflective composition in overlaying contact with the first film 64, if the first film 64 is present. A suitable embodiment of the reflective composition 50 is disclosed in U.S. Pat. No. 5,695,853.

Without limitation, the microspheres may include such materials as glass beads, cubes, or corners, resin beads, and resin hemispheres. A person of ordinary skill in the art will readily comprehend other resins suitable, depending upon the intended use and an environment, from Handbook of Plastics, Elastomers, and Composites, Third Edition, Charles A. Harper Editor-In-Chief, McGraw-Hill, New York, 1996. Suitable reflective materials may be deposited aluminum, silver, or dialectic materials, such as those taught by U.S. Pat. No. 3,700,305. Materials suitable for the first and second protective films include methyl methacrylate, polyethylene terephthalate, cellulose acetate, cellulose acetate butyrate, polyethylene, polypropylene, ethylene-acrylic acid co-polymer, the foregoing materials optionally including ultraviolet absorbers and other adjuvants. A person of ordinary skill in the art, however, will readily select other materials from the Handbook of Plastics, Elastomers, and Composites. Additionally, other materials suitable for specific embodiments are disclosed in U.S. Pat. Nos. 5,064,272 and 5,066,098.

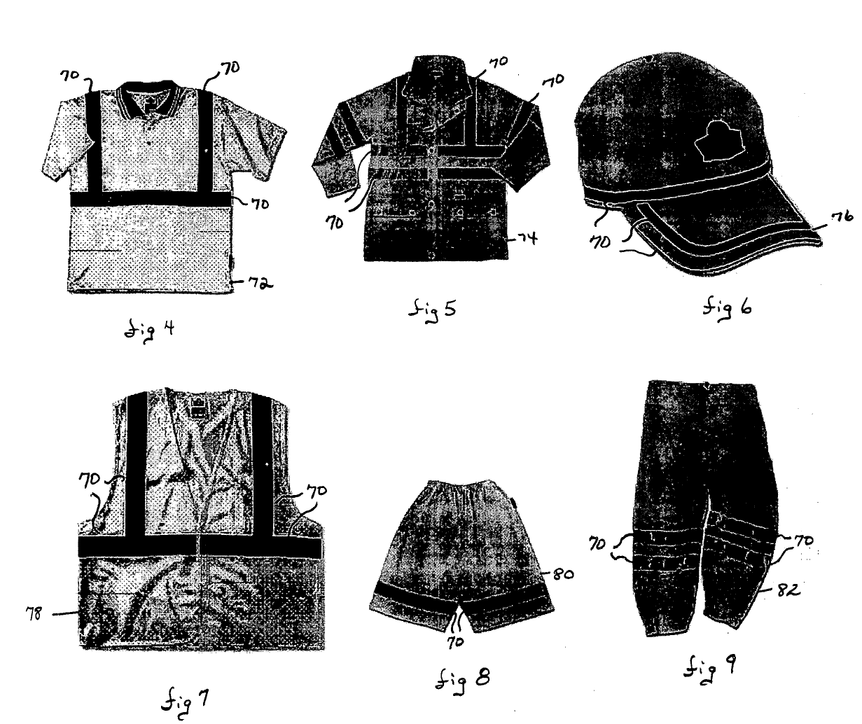

In use, the instant composition is made, or obtained, in strips, then the second protective cover is attached when the strips are affixed to garments, fixing by means or stitching or by other equivalent fasteners known to the art. While garments are exemplified herein, the present composition may encompass any substance on which a reflective material is mounted wherein additional protection against loss of the reflective property is desirable. Non-limiting examples of such other devices include exterior surfaces of panels, fuel tanks, vehicles, farm implements, and traffic signs. Additionally this invention encompasses shapes of the instant reflective composition other than strips, non-limiting examples including circles, squares, rectangles, triangles.

Wherein the respective first, second, and third compositions are collectively indicated at 70, and referring to FIGS. 4-9, the improved reflective compositions, having the additional or second protective film, are depicted as strips attached to garments such as the shirt 72 in FIG. 4, the coat 74 in FIG. 5, head wear such as the cap 76 in FIG. 6, the vest 78 in FIG. 7, the shorts 80 in FIG. 8, and the pants 82 in FIG. 9. However, the improved reflective composition of this invention may also be advantageously used with other garments such as blankets, socks, shoes, hats, sweatshirts, or any other desired item.

Because numerous modifications of this invention may be made without departing from the spirit thereof, the scope of the invention is not to be limited to the embodiments illustrated and described. Rather, the scope of the invention is to be determined by the appended claims and their equivalents.

What is claimed is:

1. A reflective garment for covering at least a portion of a user, comprising:
a fabric; and
a reflective composition attached to an outer surface of the fabric and comprising a reflective layer, optionally a first protective film and an exterior second transparent protective film.

2. The garment of claim 1, in which the first protective film is present.

3. The garment of claim 1, in which the first protective film is absent.

4. The garment of claim 1, in which the reflective composition is a strip.

5. The garment of claim 4, in which said garment is a vest, a shirt, an article of head wear, a pair of shorts, or a pair of pants.

6. The garment of claim 1, in which the reflective layer comprises a microsphere layer.

7. The garment of claim 1, in which the second film is attached to the first protective film or the garment.

8. The garment of claim 7, in which the second film is attached by stitching.

9. A reflective composition for attaching to a garment and comprising:
reflective layer comprising a plurality of microspheres;
a first transparent protective film disposed above the reflective layer; and
an exterior second transparent protective film disposed above the first protective film.

10. The reflective composition of claim 9, in which said composition is a strip.

11. The reflective composition of claim 9, in which the second film is fixed to the first film or the garment.

12. The reflective composition of claim 9, in which the second film is stitched to the garment.

13. A garment in combination with the reflective composition of claim 9, said reflective composition fixed to the garment.

14. The garment of claim 13, in which the garment is a vest, a shirt, an article of head wear, a pair of shorts, or a pair of pants.

15. A method of manufacturing a reflective garment, comprising attaching a reflective composition to the garment, the reflective composition comprising a reflective layer, an optional first transparent film disposed above the reflective layer, and a second transparent film disposed over the first film.

16. The method of claim 15, in which the second film is fixed to the garment or the first film by stitching.

17. The method of claim 15, in which the manufactured garment is a vest, a shirt, an article of head wear, a pair of shorts, or a pair of pants.

18. The method of claim 15, in which the reflective layer of the attached reflective composition includes a plurality of microspheres.

19. The method of claim 15, in which the reflective composition is a strip affixed to the garment.

20. The method of claim 19, in which the strip of reflective composition is affixed to and exterior surface of the garment.
